(19) United States
(12) Patent Application Publication
(10) Pub. No.: US 2018/0227143 A1
(43) Pub. Date: Aug. 9, 2018

(54) PROCEDES MIS EN OEUVRE PAR UN DISPOSITIF ET DANS UN RESEAU, ENTITE ELECTRONIQUE ASSOCIEE

(71) Applicant: Oberthur Technologies, Colombes (FR)

(72) Inventor: Emmanuelle DOTTAX, Colombes (FR)

(21) Appl. No.: 15/853,309

(22) Filed: Dec. 22, 2017

(30) Foreign Application Priority Data
Dec. 30, 2016 (FR) 1663575

(51) Int. Cl. H04L 12/28; H04L 29/06

(52) U.S. Cl. CPC H04L 12/2869; H04L 63/0876; H04L 63/102

(57) ABSTRACT

In a network including an application server, a network server, and a device having a memory storing an application cryptographic key, a method includes: testing the memory for the absence or presence of a cryptographic key associated with the network; if the key is absent, the device sending a request to join the network, the application server producing derivation data, the application server encrypting the derivation data by the application cryptographic key, and the device receiving the encrypted derivation data; and in the event of the key being present, the device sending a request to join the network, the network server producing derivation data, the network server encrypting the derivation data by a network cryptographic key equal to or derived from the cryptographic key associated with the network, and the device receiving the encrypted derivation data. A method performed in the device, and an associated electronic entity are also described.

TECHNICAL FIELD TO WHICH THE INVENTION RELATES

The present invention relates to methods performed by devices to join a network.

The invention relates more particularly to methods performed by a device and in a network, and also to an associated electronic entity.

The invention is particularly advantageously applicable to producing keys (such as session keys) suitable for subsequent use when exchanging data in secure manner in the network.

### TECHNOLOGICAL BACKGROUND

It is known (e.g. in LoRaWAN® technology) that an electronic device can join a network in order to be able subsequently to exchange data with an application server connected to the network.

After a stage enabling the electronic device to join the network, the electronic device and the application server are in a position to produce (each of them respectively) a session key that is used subsequently, in particular for encrypting data exchanges between the two entities.

To do this, provision is made for the electronic device and the application server both to know a shared secret, e.g. the application cryptographic key AppKey (for “Application Key”) in LoRaWAN® technology.

When the process enabling the electronic device to join the network is managed by a network server that is distinct from the application server, the process can succeed only if the application server (which holds the shared secret) is available, unless the shared secret is communicated to the network server (which is generally not desirable).

### OBJECT OF THE INVENTION

In this context, the present invention proposes a method performed by a device in order to join a network, the device comprising a memory and storing an application cryptographic key in said memory, the method comprising the following steps:
testing the memory for the absence or the presence of a cryptographic key associated with the network;
in the event of the cryptographic key associated with the network being absent, sending a request to join the network and receiving in return derivation data produced by an application server and encrypted using the application cryptographic key; and
in the event of the cryptographic key associated with the network being present, sending a request to join the network and receiving in return derivation data produced by a server associated with the network and encrypted by means of a network cryptographic key that is equal to or derived from the cryptographic key associated with the network.

The device thus adapts as a function of the data stored in the above-mentioned memory: the process enabling it to join the network may be performed by default by means of the application cryptographic key; however, if a cryptographic key associated with the network is present, then the process enabling it to join the network makes use of another cryptographic key and can thus terminate without it being necessary to access the application server, as explained below.

The method may include a step of deriving an application session key on the basis of the application cryptographic key and of the received derivation data; the application session key may be used subsequently in the context of exchanging data between the device and the application server, e.g. in order to encrypt the exchanged data.

In the event that the cryptographic key associated with the network is present, the method may also include a step of deriving a network session key on the basis of the network cryptographic key and of the received derivation data; the network session key may be used subsequently in the context of exchanging data between the device and the network server, e.g. in order to encrypt the exchanged data.

In the event of the cryptographic key associated with the network being present, the method may also include a step of deriving the network cryptographic key on the basis of the cryptographic key associated with the network (which may then be a master key, as explained below) and of an identifier of the network.

Under such circumstances, and prior to the step of deriving the network cryptographic key, provision may also be made for a step of receiving the identifier of the network from the server associated with the network.

In another potential implementation, the cryptographic key of the network may be the cryptographic key associated with the network (in which case this key is stored beforehand in the above-mentioned memory, e.g. during a stage of personalising the device).

In practice, provision may be made for the device to comprise a secure electronic entity including said memory.

The invention also proposes a method that is performed in a network including an application server, a network server, and a device including a memory storing an application cryptographic key, the method comprising the following steps:
the device testing the memory for the absence or the presence of a cryptographic key associated with the network;
in the event of the cryptographic key associated with the network being absent, the device sending a request to join the network, the application server producing derivation data, the application server encrypting the derivation data by means of the application cryptographic key, and the device receiving the encrypted derivation data; and
in the event of the cryptographic key associated with the network being present, the device sending a request to join the network, the network server producing derivation data, the network server encrypting the derivation data by means of a network cryptographic key equal to or derived from the cryptographic key associated with the network, and the device receiving the encrypted derivation data.

Finally, the invention proposes an electronic entity (e.g. a secure electronic entity) including a memory storing an application cryptographic key, a module for sending a request to join a network, a mechanism for testing the memory for the absence or the presence of a cryptographic key associated with the network, and a reception module designed to receive, in the absence of the cryptographic key associated with the network, derivation data produced by an application server and encrypted by means of the application cryptographic key, and, in the presence of the cryptographic key associated with the network, derivation data produced by a server associated with the network and encrypted by means of a network cryptographic key equal to, or derived from, the cryptographic key associated with the network.

Such an electronic entity may also include a module for deriving an application session key on the basis of the application cryptographic key and of the received derivation data.

The electronic entity may also include a module suitable, in the event of the cryptographic key associated with the network being present, for deriving a network session key on the basis of the network cryptographic key and of the received derivation data.

The electronic entity may also include a module suitable, in the event of the cryptographic key associated with the network being present, for deriving the network cryptographic key on the basis of the cryptographic key associated with the network and of an identifier of the network.

When the electronic module includes a processor (e.g. a microprocessor), the above-mentioned mechanism and/or modules may be performed at least in part by instructions that are executable by the processor and stored in a memory of the electronic entity.

### DETAILED DESCRIPTION OF AN EMBODIMENT

The following description made with reference to the accompanying drawings, which are given as nonlimiting examples, makes it clear what the invention consists in and how it can be reduced to practice.

In the accompanying drawings:

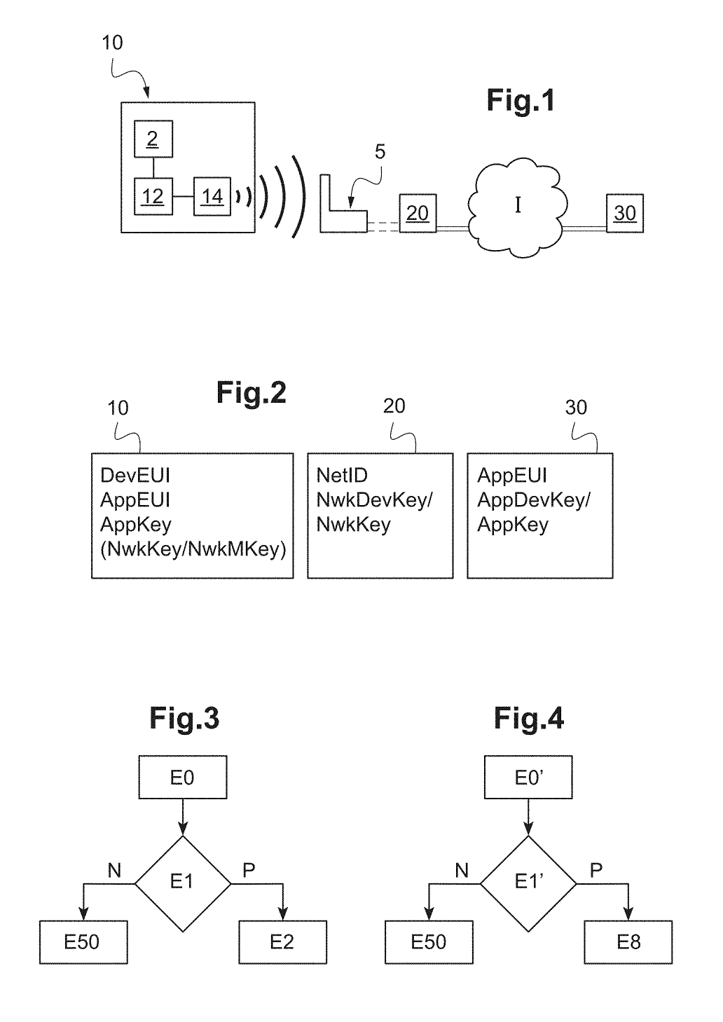

FIG. 1 shows diagrammatically the main elements of a system in which the invention can be performed;

FIG. 2 shows the data initially stored in various devices of the FIG. 1 system;

FIG. 3 shows a first possibility that can be envisaged for the initiation steps of a method in accordance with the invention;

FIG. 4 shows a second possibility that can be envisaged for the initiation steps of a method in accordance with the invention;

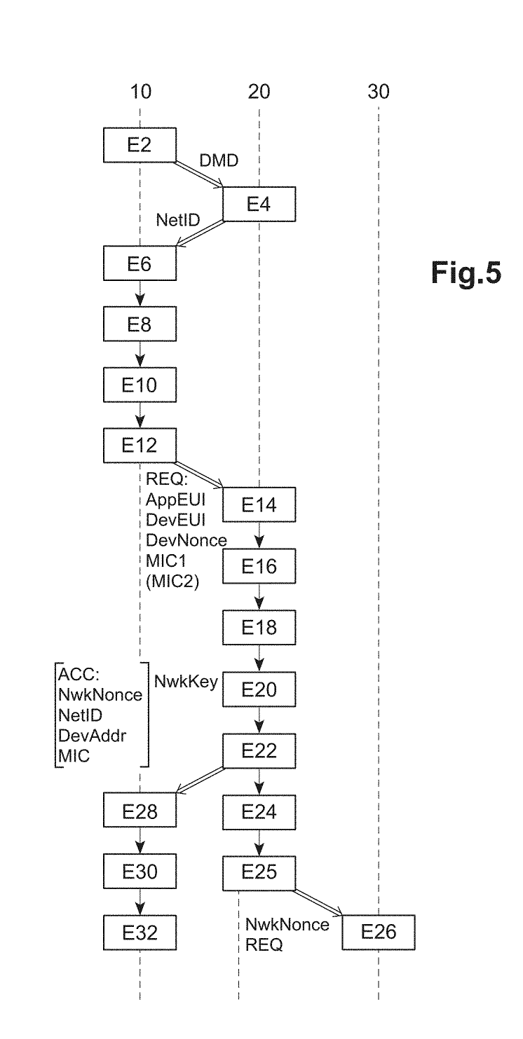

FIG. 5 shows steps of a method performed in a first situation; and

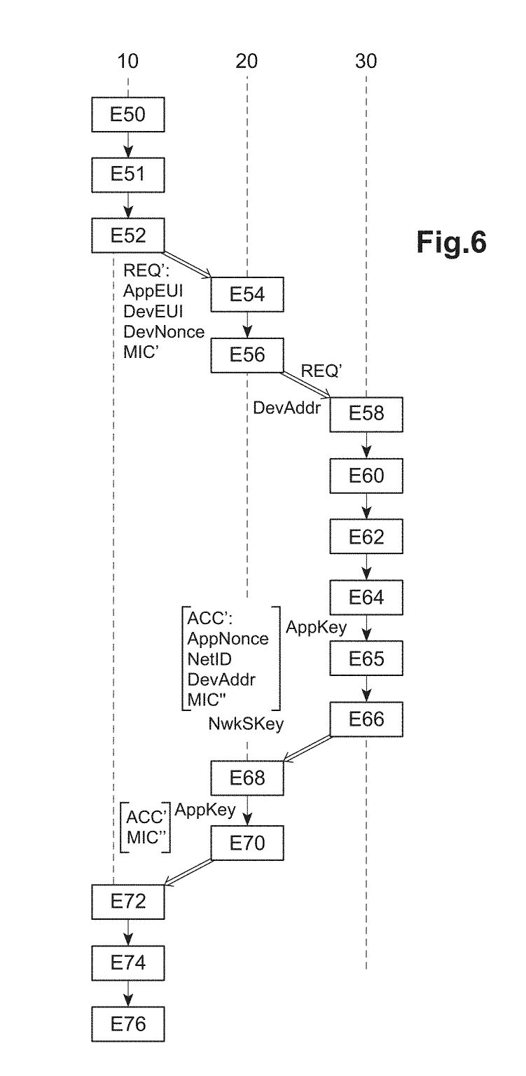

FIG. 6 shows steps of a method performed in a second situation.

FIG. 1 shows diagrammatically the main elements of a system in which the invention can be performed.

The system comprises an electronic device 10, a gateway 5, a network server 20, and an application server 30.

The electronic device 10 comprises a processor 12 (e.g. a microcontroller), an electronic entity 2, and a communication circuit 14, in this example a communication circuit designed to set up a wireless connection with the gateway 5 (i.e. via radio waves).

Typically, the electronic device 10 is a connected object, such as a measuring device (e.g. a device for measuring the supply of energy or of water), a detector (such as a smoke detector), an identifier, or a transaction terminal.

In the example described, the electronic entity 2 is a secure electronic entity, specifically a secure element (SE), embodied in this example in the form of a microcontroller. Such a secure element may optionally be integrated in the electronic device 10, e.g. by being directly bonded to the electronic device 10: the electronic entity 2 is then of the embedded secure element (eSE) type.

In a variant, the electronic entity 2 may be a microcircuit card (e.g. a universal integrated circuit card (UICC), as set out in ETSI technical specification TS 102 221), or an embedded universal circuit card (eUICC) as described in ETSI standard TS 103 383.

The electronic entity 2 comprises a processor (e.g. a microprocessor) and at least one memory, in particular in this example a rewritable nonvolatile memory. The memory stores in particular instructions designed so that the electronic entity 2 can perform at least certain steps of the methods described below with reference to FIGS. 3 to 6, when the instructions are executed by the processor of the electronic entity 2.

The memory of the electronic entity 2 also stores data used while it is in operation, in particular at least some of the data specified in FIG. 2 (described below) as being stored within the electronic device 10.

As mentioned above, the electronic entity 2 in this example is secure, i.e. the electronic entity 2 is designed, as a result of its physical construction and of the design of the computer programs it stores, to make it very difficult or even impossible for an attacker to gain access (through reading and/or modification) to the confidential data that it stores. Thus, the electronic entity 2 presents a level of security complying with the Evaluation Assurance Level (EAL) common criteria, corresponding to the standard ISO 15408, with an assurance level greater than or equal to 4, or with the Federal Information Processing Standard (FIPS) 140-2.

As mentioned above, the electronic device 10 can set up a connection (a wireless connection in this example) with the gateway 5, which is connected to the network server 20 (e.g. by means of a local network such as an Ethernet network or a wireless local network (WLAN)) so that the electronic device 10 can exchange data with the network server 20.

By way of example, the electronic device 10, the gateway 5, and the network server 20 are arranged using LoRaWAN® technology.

The network server 20 is also connected to a communication network, in this example a public communication network I such as the Internet, to which an application server 30 is also connected.

The application server 30 and the electronic device 10 need to be able to exchange data in secure manner in the context of the operation of the electronic device 10, typically in the context of the processor 12 of the electronic device 10 executing an application.

As can be seen from the above, the electronic device 10 and the application server 30 can exchange data via the gateway 5, the network server 20, and the communication network I.

There follows a description of the stage (generally performed on first connection of the electronic device 10 to the network server 20) that enables the electronic device 10 to join the network including the network server 20, and that enables cryptographic keys (referred to below as “session” keys) to be put into place for use when exchanging data between the electronic device 10 and the network server 20, and also between the electronic device 10 and the application server 30, and in particular for encrypting the data that is exchanged.

In this context, FIG. 2 shows the data initially stored in the electronic device 10, the network server 20, and the application server 30 prior to this stage enabling the electronic device 10 to join the network.

Thus, the electronic device 10 stores:
an identifier DevEUI of the electronic device 10;
an identifier AppEUI of the application in question;
an application cryptographic key AppKey; and
optionally a cryptographic key associated with the network, which may either be a master key NwkMKey, or else a network cryptographic key NwkKey.

As mentioned above, at least some of this data (in particular the above-mentioned cryptographic keys) may be stored within the secure electronic entity 2 that forms part of the electronic device 10 as stated above (thus making it possible to prevent any access to this data by an ill-intentioned person).

The data (such as the above-mentioned cryptographic keys) stored in the secure electronic entity 2 may for example be stored in a memory of the secure electronic entity 2 during a step of preparing the electronic entity 2 for subsequent operation (a step commonly referred to as a “personalization” step).

As can be seen from the explanations given below, in particular with reference to FIGS. 3 and 4, the electronic device 10 (and more particularly in this example the electronic entity 2) stores one of the cryptographic keys associated with the network when the method performed by the electronic device 10 for joining the network is to comply with the method described below with reference to FIG. 5.

The network server 20 stores a network identifier NetID and optionally (when the method performed by the electronic device 10 for joining the network is to comply with the method described below with reference to FIG. 5) a cryptographic key supplied to the network, which may either be the above-mentioned network cryptographic key NwkKey, or else a generic network key NwkDevKey.

In this example, provision is made specifically for the generic network key NwkDevKey to be a key derived on the basis of the above-mentioned master key NwkMKey (which is not distributed to the network for reasons of confidentiality) and of the network identifier NetID: NwkDevKey=d1(NwkMKey, NetID), where d1 is a derivation function.

The network cryptographic key NwkKey is itself derived on the basis of the generic network key NwkDevKey and of the identifier DevEUI of the electronic device 10: NwkKey=d2(NwkDevKey, DevEUI), where d2 is a derivation function. The network cryptographic key NwkKey is thus linked to a pair comprising the electronic device 10 and the network.

Depending on the implementation, when the method performed by the electronic device 10 for joining the network is to comply with the method described below with reference to FIG. 5, the network server 20 can thus store either the generic network key NwkDevKey (and then derive the network cryptographic key NwkKey on the basis of the identifier DevEUI), or else a network cryptographic key NwkKey for each electronic device with which the network server 20 might interact.

The application server 30 stores the identifier AppEUI of the application and the application cryptographic key AppKey (which is associated with the electronic device 10 and with that device only).

In a variant, the application server 30 could store a generic application key AppDevKey (instead of and replacing the application cryptographic key AppKey) in order to be able to derive the application cryptographic key AppKey on the basis of the generic application key AppDevKey and of the identifier DevEUI of the electronic device 10: AppKey=d3(AppDevKey, DevEUI) where d3 is a derivation function.

Provision is made in this example for the generic application key AppDevKey and the master key NwkMKey to be derived from a common root key AppRootKey (known only to the organization managing the application in question). This can simplify key management within that organization.

FIG. 3 shows a first potential possibility for the steps of initiating a method performed by the electronic device 10 in order to join the network.

In this example, the cryptographic key associated with the network and possibly stored within the electronic device 10 (specifically in the memory of the electronic entity 2) is the master key NwkMKey.

The method of FIG. 3 begins with a step E0 in which the electronic device 10 consults the memory in question (specifically the memory of the electronic entity 2) in order to determine (step E1) whether the memory contains (i.e. stores) a cryptographic key associated with the network, in this example the master key NwkMKey. By way of example, this step may be performed in practice by consulting a dedicated indicator stored in the memory in question. In a variant, this step may be performed by searching in the memory in question for a field that is identified by a specific header.

If so, the method continues from step E2, which is described below with reference to FIG. 5.

If not, the method continues from step E50, which is described below with reference to FIG. 6.

FIG. 4 shows a second potential possibility for the steps of initiating a method performed by the electronic device 10 in order to join the network.

In this example, the cryptographic key associated with the network and possibly stored within the electronic device 10 (specifically in the memory of the electronic entity 2) is the network cryptographic key NwkKey.

The method of FIG. 4 begins with a step E0′ in which the electronic device 10 consults the memory in question (specifically the memory of the electronic entity 2) in order to determine (step E1′) whether the memory contains (i.e. stores) a cryptographic key associated with the network, in this example the network cryptographic key NwkKey. By way of example, this step may be performed in practice by consulting a dedicated indicator stored in the memory in question. In a variant, this step may be performed by searching in the memory in question for a field that is identified by a specific header.

If so, the method continues from step E8, which is described below with reference to FIG. 5.

If not, the method continues from step E50, which is described below with reference to FIG. 6.

FIG. 5 shows the steps performed when a cryptographic key associated with the network (in practice here the master key NwkMKey or the network cryptographic key NwkKey) is present in the memory in question within the electronic device 10 (specifically the memory of the electronic entity 2). As can be seen from the explanations given above with reference to FIGS. 3 and 4, the method described below begins with the step E2 if the master key NwkMKey is present in the memory of the electronic device 10, and with the step E8 if the network cryptographic key NwkKey is present in the memory of the electronic device 10.

In step E2, the electronic entity 2 in the electronic device 10 issues an identifier demand DMD to the network server 20 (via the gateway 5 and using the communication circuit 14).

The network server 20 receives this identifier demand DMD and responds by issuing its network identifier NetID (step E4).

The electronic entity 2 receives the identifier NetID and can thus determine in step E6 the network cryptographic key NwkKey on the basis of the master key NwkMKey and of the network identifier NetID.

Specifically, as explained above, the electronic entity 2 begins by determining (in this example by derivation) the generic network key NwkDevKey on the basis of the master key NwkMKey and of the network identifier NetID:

NwkDevKey=d1(NwkMKey, NetID).

The electronic entity 2 can then determine the network cryptographic key NwkKey (in this example by derivation) on the basis of the generic network key NwkDevKey and of the identifier of the electronic device DevEUI:

NwkKey=d2(NwkDevKey, DevEUI).

In step E8, the electronic device 2 proceeds with determining first derivation data DevNonce, in this example by making a random draw.

Thereafter, in step E10, the electronic entity 2 prepares a message REQ containing the identifier AppEUI of the application, the identifier DevEUI of the electronic device 10, and the first derivation data DevNonce. This message REQ forms a request to join the network and may also include a corresponding specific header.

In step E10, the electronic entity 2 also determines an integrity value MIC1 for the message REQ as prepared in this way, e.g. by applying a cryptographic function (in this example of the CMAC type) to the prepared message by using the network cryptographic key NwkKey.

It should be observed that in the presently described example, the same cryptographic key NwkKey is used for calculating the integrity value MIC1 and for encrypting data including the second derivation data NwkNonce (below in step E20). Nevertheless, in a variant, it is possible to use two distinct keys: one specific key for calculating the integrity value MIC1 (used in above-described step E10 and in verification step E14, as described below) and another specific key for encryption (used in step E20 for encryption and in step E28 for decryption). In practice, these two distinct and specific keys could be derived on the basis of a common root key (and respective different derivation data).

During this step E10, the electronic entity 2 can also determine an integrity value MIC2 for the prepared message REQ, e.g. by applying a cryptographic function (in this example of the CMAC type) using the application cryptographic key AppKey to the prepared message.

Likewise, in this example, the same cryptographic key is used for calculating the integrity value MIC2 and for deriving the application session key (see below, steps E26 and E32). Nevertheless, in a variant, it is possible to use a specific key (different from the application cryptographic key AppKey) for calculating the integrity value MIC2.

In step E12, the electronic device 10 can then send the message REQ prepared in step E10 (a message requesting to join the network) and the integrity value(s) MIC1, MIC2, to the network server 20.

The network server 20 receives this data and proceeds to perform verifications in step E14.

The network server 20 can thus verify that the first derivation data DevNonce has not previously been received from this electronic device 10 (i.e. together with the identifier DevEUI that has also been received). To do this, the network server 20 can store all of the derivation data received during preceding exchanges.

If the first derivation data DevNonce has already been received, the method is terminated in order to avoid any risk of a replay attack.

If the first derivation data DevNonce has never been received beforehand, the method continues by verifying the integrity value MIC1: the network server 20 applies the cryptographic function using the network cryptographic key NwkKey to the received message REQ (including the application identifier AppEUI, the identifier DevEUI of the electronic device 10, and the first derivation data DevNonce), and it verifies that the result obtained is indeed equal to the received integrity value MIC1.

If not, the method is terminated without the electronic device 10 being able to join the network.

If so, the method continues with step E16.

It may be observed that, when the network server 20 stores the generic network key NwkDevKey, it can obtain the network cryptographic key NwkKey by derivation on the basis of the generic network key NwkDevKey and of the identifier DevEUI of the electronic device 10 (which it has just received). As mentioned above, the following applies:

NwkKey=d2(NwkDevKey, DevEUI).

Thereafter, the network server 20 produces second derivation data NwkNonce (step E16), in this example by a random draw.

In this step, the network server 20 can also generate an address DevAddr for the electronic device 10 in the network.

In step E18, the network server 20 can thus prepare a message ACC accepting the electronic device 10 in the network, this message ACC including the second derivation data NwkNonce possibly together with the network identifier NetID and/or the address DevAddr and/or a specific header.

In step E18, the network server 20 also determines an integrity value MIC for the acceptance message ACC as prepared in this way, e.g. by applying a cryptographic function (in this example of the CMAC type) using the network cryptographic key NwkKey to the prepared message. As already mentioned above, it is possible in a variant to use a specific key for calculating integrity values, which key is distinct from the network cryptographic key used below for encryption (step E20).

In step E20, the network server 20 then proceeds to encrypt the acceptance message ACC (including the second derivation data NwkNonce, the network identifier NetID, and the address DevAddr) as prepared in step E18, e.g. by means of an encryption cryptographic algorithm that uses the network cryptographic key NwkKey. This encryption may also cover the above-mentioned integrity value MIC.

In step E22, the network server 20 can thus send this encrypted message to the electronic device 10 (and specifically to the electronic entity 2 forming part of the electronic device 10). The processing that is then performed within the electronic device 10 is described below (as from step E28).

In step E24, the network server 20 also determines a network session key NwkSKey on the basis of the network cryptographic key NwkKey, of the first derivation data DevNonce, and of the second derivation data NwkNonce.

By way of example, this can be done by applying a derivation cryptographic algorithm F (optionally of the CMAC type), using the network cryptographic key NwkKey, to data comprising the first derivation data DevNonce and the second derivation data NwkNonce (and possibly also other data such as the network identifier NetID):

NwkSKey=F_{NwkKey}(NwkNonce∥NetID∥DevNonce),

where ∥ is the concatenation operator.

As mentioned above, the network session key NwkSKey can be used subsequently in the context of an exchange of data between the electronic device 10 and the network server 20, e.g. for encrypting the data that is exchanged, in particular.

Thereafter, in step E25, the network server 20 can transmit the message REQ and the second derivation data NwkNonce to the application server 30, which message REQ is as initially sent by the electronic device 10 in step E12 (and includes in particular the identifier DevEUI of the electronic device 10 and the first derivation data DevNonce).

It should be observed that this transmission may be delayed if the application server 30 is not available, but without that blocking the process that enables the electronic device 10 to join the network (with this process continuing in any event as mentioned above in step E28).

When the application server 30 receives the data sent in step E25, it can verify the integrity value MIC2 (when the integrity value MIC2 is used), in this example by means of the application cryptographic key AppKey (or in a variant by means of a specific key).

If verification is successful, the application server 30 can act in step E26 to determine an application session key AppSKey on the basis of the application cryptographic key AppKey, of the first derivation data DevNonce, and of the second derivation data NwkNonce. (If verification is not successful, then the method is terminated without generating the application session key AppSKey.)

When the application server 30 stores the generic application key AppDevKey, it can obtain the application cryptographic key AppKey by derivation on the basis of the generic application key AppDevKey and of the identifier DevEUI (that the application server 30 has just received):

AppKey=d3(AppDevKey, DevEUI).

By way of example, the application session key AppSKey is determined by applying a derivation cryptographic algorithm G (possibly of the CMAC type), using the application cryptographic key AppKey, to data comprising the first derivation data DevNonce and the second derivation data NwkNonce (possibly together with other data, such as the network identifier NetID):

AppSKey=G_{AppKey}(NwkNonce∥NetID∥DevNonce),

where ∥ is the concatenation operator.

As mentioned above, the application session key AppSKey can be used subsequently in the context of an exchange of data between the electronic device 10 and the application server 30, e.g. for encrypting the data that is exchanged, in particular.

At its end, the electronic equipment 10 (and more precisely the electronic entity 2) receives the encrypted message sent by the network server 20 in step E22 (the network acceptance message ACC encrypted by means of the network cryptographic key NwkKey).

The electronic entity 2 can then decrypt this message using the network cryptographic key NwkKey and can verify the integrity value MIC (step E28).

Specifically, the electronic entity 2 applies a decryption cryptographic algorithm using the network cryptographic key NwkKey to the received encrypted message, and can thus have access to the second derivation data NwkNonce, to the network identifier NetID, and to the address DevAddr (this data being contained in the decrypted message), and also to the integrity value MIC.

The electronic entity 2 also verifies the integrity of the received message by comparing the received integrity value MIC with the result of applying to the decrypted message the cryptographic function that made it possible to determine the integrity value MIC in step E18 (making use of the network cryptographic key NwkKey).

The electronic entity 2 (and/or the processor 12) can then store the address DevAddr as the address of the electronic device 10 in the network (step E30).

Finally, in step E32, the electronic entity 2 determines the two above-mentioned session keys:
the application session key AppSKey to be used subsequently when exchanging data with the application server 30 (in particular as the key of an encryption cryptographic algorithm applied to the data that is exchanged); and
the network session key NwkSKey to be used subsequently when exchanging data with the network server 20 (in particular as the key of an encryption cryptographic algorithm applied to the data that is exchanged).

It should be recalled that in this example, the application session key AppSKey is determined by applying a derivation cryptographic algorithm G using the application cryptographic key AppKey to data comprising the first derivation data DevNonce (produced in step E8), the second derivation data NwkNonce (received and decrypted in step E28), and also in this example the network identifier NetID.

Likewise, in this example, the network session key NwkSKey is determined by applying a derivation cryptographic algorithm F using the network cryptographic key NwkKey to data comprising the first derivation data DevNonce, the second derivation data NwkNonce, and also in this example the network identifier NetID.

The method as described above thus enables the electronic device 10 to join the network (and in particular to store its own address DevAddr in step E30) and to produce the above-mentioned session keys AppSKey, NwkSKey. It may be observed in particular that it is possible to produce the application session key AppSKey without requiring access to the application server 30 (which might thus potentially be off-line when the electronic device 10 joins the network) and without it being possible for the network server 20 to obtain the application session key AppSKey (thus making it possible to ensure that subsequent exchanges between the electronic device 10 and the application server 30 are kept confidential relative to the network server 20).

With reference to FIG. 6, there follows a description of the steps performed when no cryptographic key associated with the network (NwkMKey, NwkKey) is present in the memory in question within the electronic device 10 (in this example the memory of the electronic entity 2).

In step E50, the electronic device 2 proceeds with determining the first derivation data DevNonce, in this example by making a random draw.

Thereafter, in step E51, the electronic entity 2 prepares a message REQ′ containing the identifier AppEUI of the application, the identifier DevEUI of the electronic device 10, and the first derivation data DevNonce. This message REQ′ forms a request to join the network and may also include a corresponding specific header.

In step E51, the electronic entity 2 also determines an integrity value MIC′ for the message REQ′ as prepared in this way, e.g. by applying a cryptographic function (in this example of the CMAC type) using the application cryptographic key AppKey to the prepared message.

Specifically, in this example, the same cryptographic key AppKey is used both for calculating the integrity value MIC′ and for encrypting data including the second derivation data AppNonce (described below for step E64). Nevertheless, in a variant, it is possible to use two distinct keys: one specific key for calculating the integrity value MIC′ (used in above-described step E51 and in verification step E58, as described below) and another specific key for encryption (used in step E64 for encryption and in step E72 for decryption). In practice, these two distinct and specific keys could be derived on the basis of a common root key (and respective different derivation data).

In step E52, the electronic device 10 can then send the message REQ′ prepared in step E51 (a message requesting to join the network) and the integrity value MIC′ to the network server 20.

The network server 20 receives this data, and in step E54 verifies that the first derivation data DevNonce has not previously been received from this electronic device 10 (i.e. together with the identifier DevEUI that has also been received). To do this, the network server 20 can store all of the derivation data received during preceding exchanges.

If the first derivation data DevNonce has already been received, the method is terminated in order to avoid any risk of a replay attack.

If the first derivation data DevNonce has never been received beforehand, the method continues by transmitting the message REQ′, the integrity value MIC′, and an address DevAddr to the application server 30 (step E56). This address DevAddr (e.g. generated on this occasion) is allocated to the electronic device 10 and thus corresponds to the address of the electronic device 10 in the network. The address DevAddr may optionally be transmitted in encrypted form (e.g. by setting up a secure communication channel between the network server 20 and the application server 30).

The application server 30 receives the address DevAddr, the message REQ′ and the integrity value MIC′, and can then verify the integrity of the message REQ′ (step E58): the application server 30 applies the cryptographic function to the received message REQ′ (including the identifier AppEUI of the application, the identifier DevEUI of the electronic device 10, and the first derivation data DevNonce), in this example using the application cryptographic key AppKey, and it verifies that the result obtained is indeed equal to the integrity value MIC′ it received.

If verification is not successful, the method is terminated without the electronic device 10 being able to join the network.

If it is successful, the method continues to step E60 where the application server 30 produces second derivation data AppNonce, in this example by a random draw.

In step E62, the application server 30 can thus prepare a message ACC′ accepting the electronic device 10 in the network, this message ACC′ including the second derivation data AppNonce possibly together with the network identifier NetID and/or the address DevAddr and/or a specific header.

In step E62, the application server 30 also determines an integrity value MIC″ for the acceptance message ACC′ as prepared in this way, e.g. by applying a cryptographic function (in this example of the CMAC type) to the prepared message ACC′, using the application cryptographic key AppKey (or in a variant, a specific key for calculating integrity values, which key is different from the application cryptographic key AppKey, as mentioned above).

In step E64, the application server 30 then proceeds to encrypt the acceptance message ACC′ (including the second derivation data AppNonce, the network identifier NetID, and the address DevAddr) as prepared in step E62, e.g. by means of an encryption cryptographic algorithm that uses the application cryptographic key AppKey. This encryption may also cover the above-mentioned integrity value MIC″.

In step E65, the application server 30 also determines a network session key NwkSKey and an application session key AppSKey.

Each of the session keys NwkSKey, AppSkey is determined on the basis of the application cryptographic keys AppKey, of the first derivation data DevNonce, and of the second derivation data AppNonce (and in this example of the network identifier NetID).

By way of example, this can be done by means of a derivation cryptographic algorithm H that uses the application cryptographic key AppKey and that is applied to slightly different data for the application session key AppSKey and for the network session key NwkSKey:

NwkSKey=H_{AppKey}(0×01∥AppNonce∥NetID∥DevNonce);

AppSKey=H_{AppKey}(0×02∥AppNonce∥NetID∥DevNonce)

where 0×01 is the value 1 in hexadecimal, where 0×02 is the value 2 in hexadecimal, and where ∥ is the concatenation operator.

As mentioned above, the network session key NwkSKey may subsequently be used for exchanging data between the electronic device 10 and the network server 20, e.g. for encrypting the data that is exchanged, in particular; the application session key AppSKey may subsequently be used when exchanging data between the electronic device 10 and the application server 30, e.g. for encrypting the data that is exchanged, in particular.

In step E66, the application server 30 sends the encrypted message ACC′ and the network session key NwkSKey to the network server 20. The network session key NwkSKey may optionally be transmitted in encrypted form (e.g. by setting up a secure communication channel between the network server 20 and the application server 30).

In step E68, the network server 20 receives the network session key NwkSKey and stores this network session key NwkSKey for subsequent use.

In step E70, the network server 20 also transmits this encrypted message ACC′ to the electronic device 10 (and specifically to the electronic entity 2 forming part of the electronic device 10).

The electronic equipment 10 (and more precisely the electronic entity 2) receives the encrypted message sent by the network server 20 in step E70 (the network acceptance message ACC′ encrypted by means of the application cryptographic key AppKey).

The electronic entity 2 can then decrypt this message using the application cryptographic key AppKey and can verify the integrity value MIC″ (step E72).

Specifically, the electronic entity 2 applies a decryption cryptographic algorithm using the application cryptographic key AppKey to the received encrypted message, and can thus have access to the second derivation data AppNonce, to the network identifier NetID, and to the address DevAddr (this data being contained in the decrypted message), and also to the integrity value MIC″.

The electronic entity 2 also verifies the integrity of the received message by comparing the received integrity value MIC″ with the result of applying to the decrypted message the cryptographic function that made it possible to determine the integrity value MIC″ in step E62 (making use in this example of the application cryptographic key AppKey, or in a variant of a specific key).

The electronic entity 2 (and/or the processor 12) can then store the address DevAddr as the address of the electronic device 10 in the network (step E74).

Finally, in step E76, the electronic entity 2 determines the two above-mentioned session keys AppSKey, NwkSkey (using the same process as mentioned above in step E65).

1. A method performed by a device in order to join a network;
the device comprising a memory and storing an application cryptographic key in said memory;
the method comprising the following steps:
testing the memory for the absence or the presence of a cryptographic key associated with the network;
in the event of the cryptographic key associated with the network being absent, sending a request to join the network and receiving in return derivation data produced by an application server and encrypted using the application cryptographic key; and
in the event of the cryptographic key associated with the network being present, sending a request to join the network and receiving in return derivation data produced by a server associated with the network and encrypted by means of a network cryptographic key that is equal to or derived from the cryptographic key associated with the network.

2. A method according to claim 1, including a step of deriving an application session key on the basis of the application cryptographic key and of the received derivation data.

3. A method according to claim 1, including, in the event of the cryptographic key associated with the network being present, a step of deriving a network session key on the basis of the network cryptographic key and of the received derivation data.

4. A method according to claim 1, including, in the event of the cryptographic key associated with the network being present, a step of deriving the network cryptographic key on the basis of the cryptographic key associated with the network and of an identifier of the network.

5. A method according to claim 4, including a step of receiving the identifier of the network from the server associated with the network.

6. A method according to claim 1, wherein the network cryptographic key is the cryptographic key associated with the network.

7. A method according to claim 1, wherein the device comprises a secure electronic entity including said memory.

8. A method performed in a network comprising an application server, a network server, and a device including a memory storing an application cryptographic key;
the method comprising the following steps:
the device testing the memory for the absence or the presence of a cryptographic key associated with the network;
in the event of the cryptographic key associated with the network being absent, the device sending a request to join the network, the application server producing derivation data, the application server encrypting the derivation data by means of the application cryptographic key, and the device receiving the encrypted derivation data; and
in the event of the cryptographic key associated with the network being present, the device sending a request to join the network, the network server producing derivation data, the network server encrypting the derivation data by means of a network cryptographic key equal to or derived from the cryptographic key associated with the network, and the device receiving the encrypted derivation data.

9. An electronic entity comprising:
a memory storing an application cryptographic key;
a module for sending a request to join a network;
a mechanism for testing the memory for the absence or the presence of a cryptographic key associated with the network; and
a reception module designed to receive, in the absence of the cryptographic key associated with the network, derivation data produced by an application server and encrypted by means of the application cryptographic key, and, in the presence of the cryptographic key associated with the network, derivation data produced by a server associated with the network and encrypted by means of a network cryptographic key equal to, or derived from, the cryptographic key associated with the network.

10. An electronic entity according to claim 9, including a module for deriving an application session key on the basis of the application cryptographic key and of the received derivation data.

11. An electronic entity according to claim 10, including a module suitable, in the event of the cryptographic key associated with the network being present, for deriving a network session key on the basis of the network cryptographic key and of the received derivation data.

12. An electronic entity according to claim 9, including a module suitable, in the event of the cryptographic key associated with the network being present, for deriving the network cryptographic key on the basis of the cryptographic key associated with the network and of an identifier of the network.
